(19) United States
(12) Patent Application Publication
(10) Pub. No.: US 2026/0237306 A1
(43) Pub. Date: Aug. 13, 2026

(54) INFLIGHT PLANNING FOR LANDING OUTSIDE FIXED VERTIPORT NETWORKS

(71) Applicant: Volocopter Technologies GmbH, Bruchsal (DE)

(72) Inventors: Markus Ortlieb, Karlsruhe (DE); Florian-Michael Adolf, Frankfurt (DE)

(73) Assignee: Volocopter Technologies GmbH, Bruchsal (DE)

(21) Appl. No.: 19/461,568

(22) Filed: Jan. 27, 2026

Related U.S. Application Data
(63) Continuation of application No. 18/494,844, filed on Oct. 26, 2023.

(30) Foreign Application Priority Data
Oct. 28, 2022 (EP) 22204470.3

(51) Int. Cl. G08G 5/55; G08G 5/26; G08G 5/34; G08G 5/58; G08G 5/59; G08G 5/74

(52) U.S. Cl. CPC G08G 5/55; G08G 5/26; G08G 5/34; G08G 5/58; G08G 5/74; G08G 5/59

(57) ABSTRACT

A method of controlling an aircraft that operates in a network of fixed landing platforms, includes defining at least one alternate landing area) having an entry point and an exit point; b) pre-planning at least one flight trajectory to the entry point; c) automatically steering the aircraft along the flight trajectory; d) to perform a landing procedure at the alternate landing area, transferring control of the aircraft to an online planning device, preferably on board the aircraft, upon reaching the entry point; e) automatically scanning the alternate landing area, preferably according to a predetermined search pattern, and searching the alternate landing area for a landing site by active sensor technology; f) if a suitable landing site is identified, automatically carrying out a landing procedure of the aircraft at the landing site by the online planning device, otherwise g) automatically steering the aircraft to the exit point.

### CROSS-REFERENCE TO RELATED APPLICATIONS

This continuation application claims priority to pending U.S. patent application Ser. No. 18/494,844, filed Oct. 26, 2023, which claims priority to European Patent Application No. 22204470.3, filed Oct. 28, 2022, with each incorporated herein by reference as if fully set forth.

### TECHNICAL FIELD

The invention relates to a method of controlling an aircraft, preferably an electrically powered eVTOL (vertical take-off and landing) aircraft or multicopter, which aircraft operates in a network of landing platforms or vertiports.

The invention also relates to a flight control system for performing the method in accordance with the present invention.

### BACKGROUND

The company Skyryse is taking an approach to empowering amateur pilots to pilot a plane or helicopter. This involves a type of autopilot that abstracts the control of the aircraft and takes over critical tasks, allowing the pilot to control the aircraft with simple inputs via a touchscreen, cf. https://skyryse.com/technology.

There is also extensive academic literature that addresses the design of optionally piloted flight vehicles (OPVs) or the conversion of existing aircraft to OPVs. However, in most cases these approaches only cover the actual control of the aircraft by an amateur pilot, not the underlying planning problem.

The planning and flight guidance problem of having an (e)VTOL perform semi-automated landings on unprepared outdoor surfaces outside a network of dedicated vertiports is not solved in the state of the art. Conceivable application scenarios include flying to open areas near motorways to carry out rescue and HEMS (Helicopter Emergency Medical Services) missions, or to bring an emergency doctor as close as possible to the scene of an accident, or to connect rural areas to an urban vertiport network. In doing so, the emergency doctor or any other passenger, as an amateur pilot, can monitor an aircraft's autopilot and make the decision to fly to a safe alternate landing site should this become necessary.

### SUMMARY

It is the object of the present invention to devise a method a system that can be used to solve the planning and flight guidance problem of having an (e)VTOL perform semi-automated landings on unprepared outdoor surfaces outside a network of dedicated vertiports in a safe and affordable way.

This object is solved by a method and by a system having one or more of the features disclosed herein.

Advantageous embodiments are defined below and in the claims.

According to a first aspect of the invention, a method of controlling an aircraft, which aircraft operates in a network of landing platforms, comprises:
a) defining at least one alternate landing area having at least one entry point and at least one exit point;
b) pre-planning at least one flight trajectory to the entry point;
c) automatically steering the aircraft along the flight trajectory;
d) to perform a landing procedure at the alternate landing area, transferring control of the aircraft to an online planning device, preferably on board the aircraft, upon reaching the entry point;
e) automatically scanning the alternate landing area, preferably according to a predetermined search pattern, and searching the alternate landing area for a suitable landing site for the aircraft by means of active sensor technology;
f) if a suitable landing site for the aircraft is identified, automatically carrying out a landing procedure of the aircraft at the landing site by the online planning device, otherwise
g) automatically steering the aircraft to the exit point.

According to a second aspect of the invention, a flight control system for performing the method according to said first aspect of the invention, comprises: a pre-planning device adapted to define at least one alternate landing area having at least one entry point and at least one exit point, and to pre-plan a flight trajectory to the entry point;
a flight control device or controller adapted to automatically control an aircraft along the flight trajectory;
an online planning device, preferably on board the aircraft, adapted, upon reaching the entry point, to perform a landing procedure and to control the aircraft accordingly, for which purpose the online planning device is adapted to:
(i) automatically fly the aircraft over the alternate landing area, preferably according to a predetermined search pattern, and search the alternate landing area for a suitable landing site for the aircraft in operative connection with active sensor technology of the aircraft;
(ii) upon identification of a suitable landing site for the aircraft, automatically performing a landing of the aircraft at the landing site, otherwise
(iii) automatically steering the aircraft to the exit point.

At this point, the flight control device is preferably adapted to take over again and to automatically steer the aircraft along a (pre-planned) flight trajectory to landing at a predetermined alternate landing site outside of said alternate landing area.

In the context of the present invention, the flight control device and the online planning device need not be distinct and separate entities. For instance, the flight control device may comprise said online planning device (in the form of a module or algorithm) which online planning device provides control input to the flight control device during online planning procedures (or phases), whereas otherwise the flight control device operates on pre-planned data (in combination with online input from the aircraft's sensors).

Areas where outlandings, i.e., landings outside said vertiport network are expected (e.g., along motorways, in skiing areas, at race tracks, at festivals, football stadiums or the like) can be discretised into sub-areas (herein referred to as alternate landing areas) to which flight trajectories can be planned in advance from a (central) vertiport. Such areas are referred to as vertiport replacement areas or alternate landing areas. The planning of flight trajectories to these vertiport replacement areas or alternate landing areas follows the same criteria as the planning of regular flight trajectories for VTOLs within the network. This includes the definition of alternate landing sites outside of said areas, as well as the advance planning of alternate routes to these alternate landing sites. Discrete entry and exit points are also defined for said alternate landing areas, via which a given alternate landing area is flown to (entered) and from (exited). Routes from an exit point to the nearest alternate landing site can also be pre-calculated. Any such pre-planned or pre-calculated trajectories are advantageously stored on board the aircraft for steering (i.e., controlling the motion of) the aircraft accordingly.

As soon as an alternate landing area is reached, an online planning algorithm (or online planning method/procedure, preferably performed by an online planning device on board the aircraft) takes over, which online planning algorithm tries to identify a suitable landing site within the alternate landing area by means of active sensors (active sensor technology) installed on the aircraft (e.g., lidar sensors and/or radar sensors and/or cameras) and then carries out the landing at the identified landing site.

In case of an unforeseen event requiring an aborted landing, or if no suitable landing site can be found, or if the amateur pilot on board the aircraft manually aborts the landing, a preferred embodiment foresees that a pre-defined alternate landing site is approached from the (nearest) exit point via a pre-planned trajectory. By providing such a safe alternative planning solution that can be validated in advance, safety of the mission can be ensured even if it is not certain that a landing can be made at the destination, i.e., within the alternate landing area.

In a preferred embodiment, the passenger acts as an amateur pilot who monitors the complex software function of the online planner (online planning algorithm) and can initiate mitigation measures, if necessary.

In many applications, areas in which landings are potentially to be carried out away from fixed vertiports can be roughly delimited. For example, areas along motorways are potentially interesting for rescue operations, or green areas near large events are potentially interesting for the duration of the event. Larger areas can be divided into individual alternate landing areas (so-called VEFs), which can be flown to instead of a fixed vertiport. Preferably, VEFs are defined so that they are convex in shape and free of obstacles at the defined overflight height. When the shape of an VEF is convex, it is easier to contain the online planner inside the VEF while searching for a landing site, as any straight-line connection between two points will respect the limits of the shape. With concave shapes, the online planning becomes more complex as it has to implement an obstacle-awareness or awareness of the shape's boundaries, which is algorithmically the same as obstacle awareness. However, the present application is not limited to using convex shapes.

VEFs are flown to or from, respectively, through entry points and exit points that are also preferably defined in advance. Trajectories from a regular vertiport to the entry and exit points of each VEF are pre-planned and preferably stored in suitable data format on board the aircraft. Likewise, alternate landing sites (ALS), i.e., at least one such ALS, where the aircraft can land in case of a mission abort or any other unforeseen event, are preferably pre-defined outside the VEFs.

The invention is independent of a specific planning procedure used for the pre-planning of flight trajectories. Possible methods are described, for example, in patent applications DE 10 2019 103 173 A1 and DE 10 2020 105 793 A1, which are incorporated by reference.

If a VEF is to be approached, the aircraft preferably follows a pre-planned path until reaching the entry point of the VEF. At the VEF, an online planning procedure then takes over control of the aircraft, by means of which the VEF is preferably flown over the VEF with a predefined search pattern. Obstacles potentially present in the VEF can be detected by sensors on board the aircraft and can thus be automatically avoided. Also, by means of active sensors (cameras, lidar, radar, etc.), a landing site recognition algorithm can be used that searches for a suitable landing site within the VEF.

Criteria for the selection of such a suitable landing site preferably include freedom from obstacles, vegetation, ground conditions and inclination. If a suitable landing area is identified, the online planner preferably carries out an immediate landing and controls the aircraft accordingly.

If, on the other hand, no suitable landing site is found in the VEF, or if a remaining flight time of the aircraft falls below a critical value during the search, the aircraft can be automatically guided to the nearest exit point and from there heads for the nearest ALS via a pre-planned path. If routes between entry points and exit points of several VEFs are also taken into account in the pre-planning, a new landing attempt can also be made in a neighbouring VEF, if the remaining flight time of the aircraft permits.

To safeguard the online planning procedure and to mitigate the risk of incorrect landing selection, the aircraft can preferably be monitored by a passenger (i.e., a person on board the aircraft) in the aircraft or by a so-called remote operator at least during the online planning phase within the VEF. The passenger or the remote operator then acts as pilot-in-command (PIC). The remote operator controls the aircraft from a control station on the ground, which communicates with the aircraft via a data link. In the event of a malfunction or the like, the PIC can manually abort the landing procedure, and the aircraft then automatically flies to the nearest ALS via a pre-planned route. In the case of a supervising passenger on board, a simple and unambiguous human-machine interface can be provided. In the simplest case, this may be a “large red button”.

In a further embodiment of the invention, a new VEF, i.e., a suitable data representation thereof, can be transmitted, for example, from a drone or a ground-based task force to the aircraft while the aircraft is already on approach to a VEF. In this case, the approach to the new VEF will also be carried out, at least in part, using the online planning procedure, since no pre-planned trajectory exists. The monitoring task of the PIC (on board or on the ground) is thus preferably extended to this phase of the flight.

Furthermore, additional information on the topography and condition of a VEF can be transmitted by on-site reconnaissance units (said ground-based task force), which may simplify the subsequent finding of a landing site within the VEF.

The following embodiments of the invention have proved particularly advantageous:

In one embodiment of the method according to the invention obstacles in a vicinity of or within the alternate landing area are detected by the sensor technology and automatically avoided by controlling the aircraft accordingly.

This makes the search for suitable landing sites within an alternate landing area safer.

In one embodiment of the method according to the invention at least one alternate landing site, preferably outside said alternate landing area, is determined in advance and an emergency flight trajectory from the exit point to the alternate landing site is pre-planned and preferably stored on board the aircraft in a suitable data format for use by a flight control device for controlling the aircraft.

This enables safe landing at said alternate landing site if no suitable landing site is found within the VEF.

In a corresponding embodiment of the method according to the invention, following step g), the aircraft is automatically steered along the emergency flight trajectory to the alternate landing site and preferably landed there.

In yet another embodiment of the method according to the invention step g) is performed if during the search no landing site is found and/or a remaining flight time of the aircraft falls below a critical value. Preferably, the aircraft is then automatically steered along the emergency flight trajectory to the alternate landing site and landed there, as stated before.

In one embodiment of the method according to the invention a plurality of alternate landing areas and additional flight trajectories between the respective entry points and exit points of the plurality of alternate landing areas are determined in advance, and, following step g), a new landing attempt at another alternate landing area is automatically performed by automatically steering the aircraft to the relevant entry point of the other alternate landing area, whereupon the method is continued in step d).

As explained before, a new landing attempt can then be made in a neighbouring VEF, if the remaining flight time of the aircraft permits.

In one embodiment of the method according to the invention an operation of the aircraft is monitored at least during steps e) to g) in the course of an online planning phase in the vicinity of or within the alternate landing area by a person on board the aircraft or by a remote operator controlling the aircraft from a control station located on the ground, which control station communicates with the aircraft via a data link, which person or which remote operator acts as pilot-in-command, PIC, of the aircraft.

In this way, the PIC can monitor a functioning of the online planning algorithm and intervene in the event of problems.

In one further embodiment of the method according to the invention, in the event of a malfunction of the aircraft, the PIC may terminate the landing procedure, thereby automatically activating a procedure by which the aircraft is automatically steered along the emergency flight trajectory to the alternate landing site. This has already been explained above.

In one other embodiment of the method according to the invention, in the event of surveillance or monitoring by a person on board the aircraft, termination of the landing procedure is preferably effected by actuation of a dedicated human-machine interface (HMI) on board the aircraft. This HMI can take the form of a “large red button” or the like so that it is easily visible by said person.

In yet another embodiment of the method according to the invention a further alternate landing area is determined by an unmanned aerial vehicle (a drone) or by a ground crew and transmitted to the aircraft in the form of suitable data.

In this way, the choice of alternated landing areas can be enlarged in a flexible way and in reaction to additional requirements.

In a highly advantageous embodiment of the method according to the invention, with an aircraft already on approach to a VEF in accordance with step c), an approach to an entry point of the further alternate landing area is executed by the online planning device.

This enables the use of further VEFs even if no pre-planned trajectory to their respective entry points exists.

In one further embodiment of the method according to the invention the surveillance by the PIC is extended to the approach to the entry point of the further alternate landing area.

This may further increase the safety of the proposed method.

In another highly advantageous embodiment of the method according to the invention a ground crew may determine additional on-site information on the topography and condition of an alternate landing area and transmit said information to the aircraft in the form of suitable data, which data facilitates the subsequent finding of a landing site by the aircraft, i.e., the online planning algorithm.

A preferred further embodiment of the system in accordance with said second aspect of the invention comprises a monitoring device which can be located on board the aircraft and by means of which an operation of the aircraft can be monitored at least during the method steps e) to g) in the course of an online planning phase in the vicinity of or within the alternate landing area by a person on board the aircraft or by a remote operator, which remote operator is adapted to control the aircraft from a control station located on the ground, which control station is connected to the aircraft via a data link, wherein the person or remote operator acts as pilot-in-command, PIC. Said monitoring device is further adapted to enable the PIC to abort or terminate the landing procedure in the event of a malfunction of the aircraft, in which case the flight control device is adapted to automatically steer the aircraft along an emergency flight trajectory to an alternate landing site. Preferably, the monitoring device comprises a dedicated human-machine interface (HMI) for the abort. This HMI can take the form of a “large red button” or the like so that it is easily visible by said person.

### BRIEF DESCRIPTION OF THE DRAWINGS

Additional features will become apparent from the attached drawings that are used to describe preferred embodiments of the invention in exemplary fashion.

FIG. 1 shows an overview of a flight network with a (central) vertiport, a plurality of alternate landing sites as well as a plurality of vertiport replacement areas next to a road with corresponding associated entry and exit points;

FIG. 2 shows the flight over the substitute area and the recognition of a suitable landing site;

FIG. 3 shows a flow chart of an embodiment of the method according to the invention; and

FIG. 4 shows an aircraft with a system according to the invention.

### DETAILED DESCRIPTION

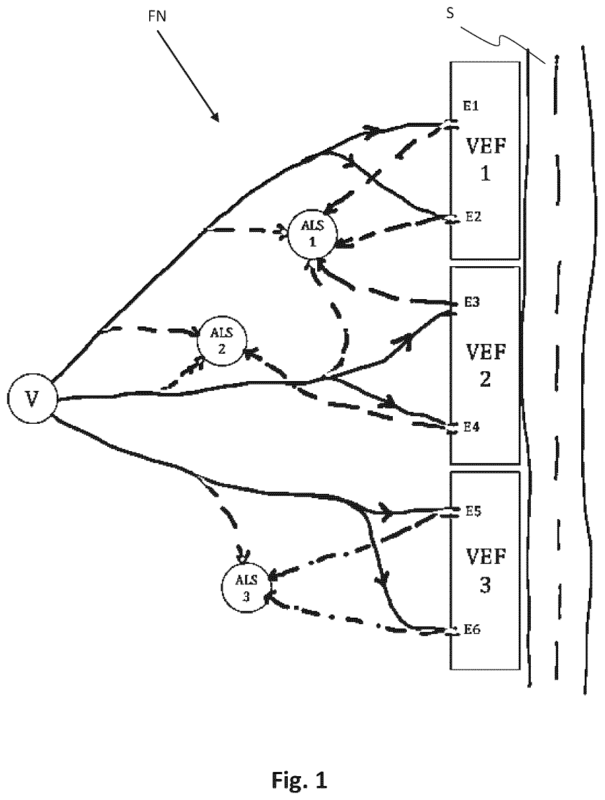

FIG. 1 shows a flight network FN comprising at least one fixed central landing site (vertiport) V. The network FN may comprise further fixed landing sites that are not shown in FIG. 1. Reference numeral S denotes a road along which a plurality of alternate landing areas VEF1 to VEF 3 are designated. Each alternate landing area VEF1 to VEF 3 has an entry point and an exit point respectively. These latter points are designated by reference numerals E1 to E6. Furthermore, three alternative landing points are shown in FIG. 1, which are designated with reference numerals ALS 1 to ALS3. There are pre-planned flight trajectories, which are marked in FIG. 1 with solid arrows and dashed arrows, respectively. Such pre-planned flight trajectories lead from the landing site V to the said entry and exit points E1-E6, from the landing site V to the alternate landing sites ALS1 to ALS3, and from the entry and exit points E1 to E6 to the alternate landing sites ALS1 to ALS3, as shown. Entry points can serve as exit points, and vice versa.

During normal flight operations within the flight network FN, aircraft move along said pre-planned flight trajectories and perform landing manoeuvres at the fixed landing site V, at the alternate landing sites ALS1 to ALS3 and within the areas VEF1 to VEF3, as will be discussed in more detail below. Specifically, the areas VEF1 to VEF3 serve to enable an aircraft to land as close as possible to the road S, even if there are no fixed landing sites in this area.

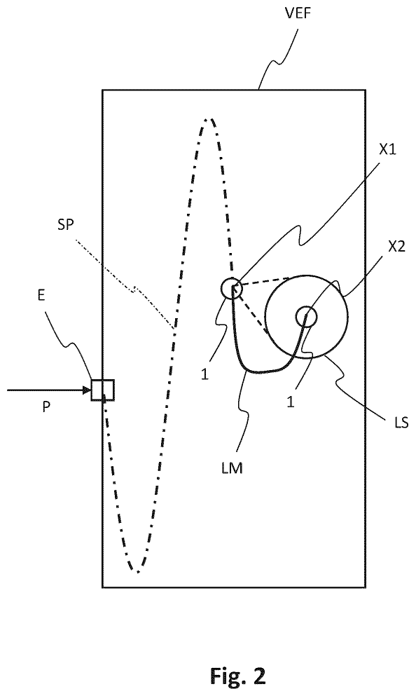

Aircraft fly into and out of the areas VEF1 to VEF3, respectively, at the entry and exit points E1 to E6. FIG. 2 shows a simplified example of such a case for an area VEF. Reference numeral E indicates the entry point. The solid arrow P indicates a pre-planned flight trajectory to the entry point E. From this point E, an online planning device or algorithm on board the aircraft takes over control of the aircraft (schematically depicted by reference numeral 1). At entry point E, the aircraft 1 flies into the area VEF and searches this area, preferably according to a predefined search scheme or pattern SP (dash-dotted line), for a suitable landing site. For this purpose, the aircraft 1 uses active sensors on board, such as radar or cameras. As soon as the aircraft 1 has found a suitable landing site (at reference numeral X1), it automatically performs a landing manoeuvre or landing procedure according to the solid line LM and lands at the landing site found (at reference numeral X2). Reference numeral LS indicates this detected suitable landing site.

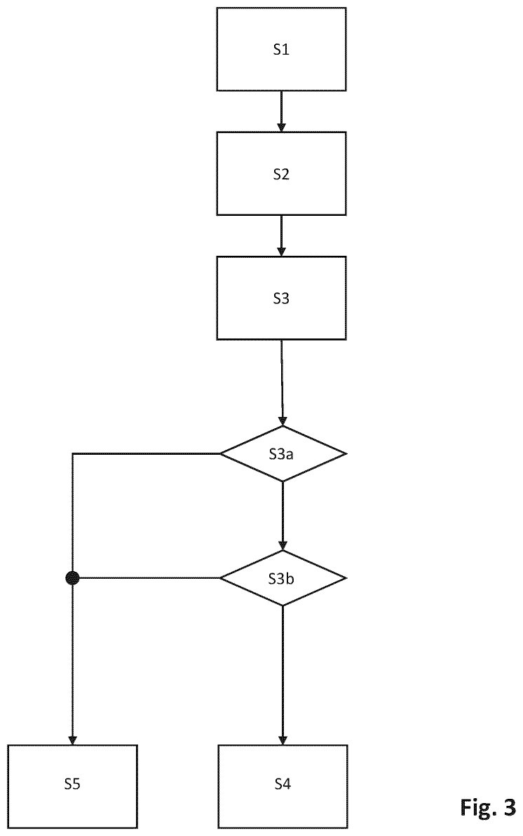

FIG. 3 shows a flow chart of the course of events in an embodiment of the method according to the invention. The method begins in step S1 with the take-off of the aircraft at a fixed landing site (or vertiport, cf. reference numeral V in FIG. 1). In step S2, the aircraft flies along a pre-planned route (flight trajectory) to an alternate landing area (VEF1-VEF3 in FIG. 1, VEF in FIG. 2). As soon as the alternate landing area is reached, the method switches to an online planning procedure in step S3. This normally results in the aircraft landing within the alternate landing area in step S4, as described above with reference to FIG. 2.

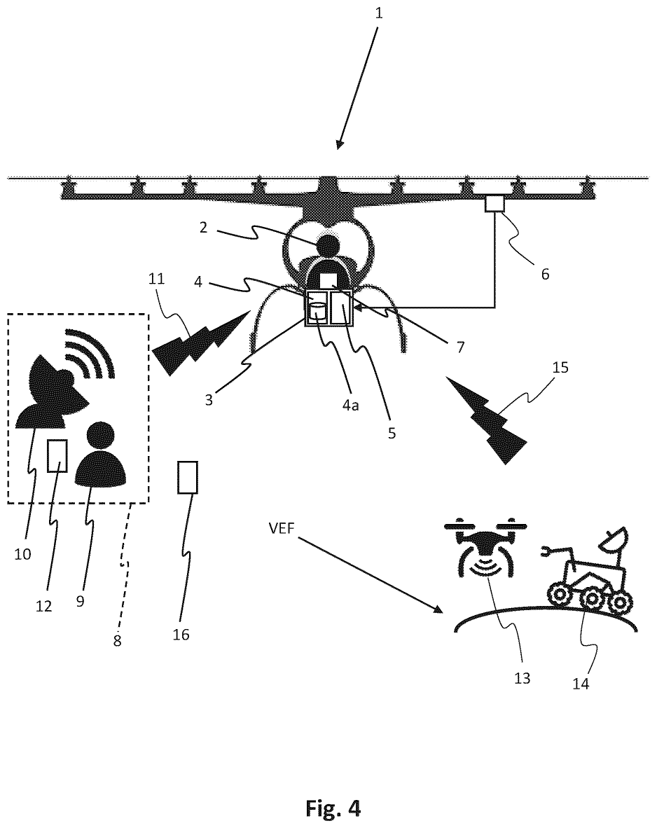

Between step S3 and step S4, certain queries are repeatedly made: in step S3a, it is queried whether the online planning procedure has been aborted by a passenger of the aircraft or by a remote operator (cf. FIG. 4). If this is the case, the aircraft automatically leaves the alternate landing area (VEF1-VEF3; see FIG. 1) through a corresponding exit point (E1-E6; see FIG. 1) and automatically performs a landing at an alternate landing site in step S5 (ALS1-ALS3; see FIG. 1). In step S3b it is queried whether the aircraft has already found a suitable landing site within the alternate landing area during the online planning procedure (see FIG. 2). If this is not the case, or if the remaining flight time of the aircraft has reached a critical value, the aircraft also automatically leaves the alternate landing area (VEF1-VEF3; see FIG. 1) through a corresponding exit point (E1-E6; see FIG. 1) and a landing at an alternate landing site is also carried out in step S5 (ALS1-ALS3; see FIG. 1).

FIG. 4 schematically shows a possible design of the system according to the invention for carrying out the method according to the invention.

Reference numeral 1 shows an aircraft in the form of an electrically driven multi copter, wherein the present invention is preferably used. On board the aircraft 1 is a passenger 2, which passenger 2 is preferably not trained as a pilot. The aircraft 1 has a flight control device or flight control device designated by reference numeral 3. The flight control device 3 is a computing device that set up, for example by corresponding firmware or software, to provide at least one path-following module 4, which path-following module 4 is set up and intended to automatically control (or steer) the aircraft 1 along a pre-planned flight trajectory, for which purpose suitable pre-planned data can be stored in a memory device 4a of the flight control device 3. Furthermore, the flight control device 3 is adapted to provide, for example by corresponding firmware or software, an online planning device 5, which online planning device 5 is adapted and intended to automatically carry out an online planning procedure or online planning algorithm for controlling the aircraft 1, as already described above with reference to FIG. 2. For this purpose, the online planning device 5 interacts with active sensor technology of the aircraft 1, which sensor technology is designated by the reference numeral 6 and is shown only schematically in FIG. 4. Preferably, said sensor system 6 comprises radar, lidar, cameras or the like.

In order for the passenger 2 to be able to abort the online planning procedure at any time, a dedicated human-machine interface 7, for example in the form of a large red button, is provided, by pressing of which the passenger 2 can ensure that the aircraft 1 automatically lands at a predetermined alternate landing site, as already described in detail above. Said man-machine interface 7 thus serves as a monitoring device with which an operation of the aircraft 1 can be monitored at least during the method steps e) to g) in the course of an online planning phase in the vicinity of or within an alternate landing area.

Reference numeral 8 indicates a ground station operated by a so-called remote operator 9. The ground station 8 is, via suitable transmitting and receiving means 10, in communication with the aircraft 1 (cf. data link at reference numeral 11). The ground station 8 is designed in such a way that the remote operator 9 can remotely control the aircraft 1 via a suitable man-machine interface 12. In the course of one embodiment of the present invention, it can be provided in particular that the remote operator 9 via the interface 12 is also able to interrupt the online planning procedure at any time so that the aircraft 1 automatically lands at a predetermined alternate landing site, as has already been described in detail above. Said man-machine interface 12 thus also serves as a monitoring device which an operation of the aircraft 1 can be monitored at least during the method steps e) to g) in the course of an online planning phase in the vicinity of or within an alternate landing area.

Data or (topographical) information about an alternate landing area VEF may be transmitted to the aircraft 1 by a pre-sent drone 13 and/or by a ground crew 14. Such data can help to find a suitable landing site, as shown in FIG. 2, more easily or more quickly. The drone 13 or the ground crew 14 are also able to indicate ad hoc to the aircraft 1 the existence of a new alternate landing area (cf. data link at reference numeral 15), whereupon the aircraft 1 can directly approach this new alternate landing area even without a pre-planned trajectory in the online planning mode, even if it is already in the approach to another alternate landing area.

Also shown in FIG. 4 is a pre-planning device 16 adapted to define at least one alternate landing area as described above, i.e., having at least one entry point and at least one exit point, and to pre-plan at least a flight trajectory to the entry point. Said pre-planning device 16 is further devised to provide any suitable pre-planned data to be stored in said memory device 4a of the flight control device 3 (cf. FIG. 1 and corresponding description). Corresponding data can be provided to aircraft 1 in wireless fashion or via cable, preferably while aircraft 1 is grounded. Pre-planning device 16 can but need not be part of ground station 8. At least part of it could be installed in aircraft 1.

1. A method, the method comprising:
controlling an aircraft operating in a network of fixed vertiports to operate outside said network of fixed vertiports by:
pre-defining at least one alternate landing area for operating said aircraft outside said network of fixed vertiports, said alternate landing area having at least one entry point and at least one exit point;
pre-planning at least one flight trajectory to the entry point;
automatically steering, by a flight control device of the aircraft, the aircraft along the flight trajectory;
upon reaching the entry point, transferring, by the flight control device, control of the aircraft to an online planning device of the aircraft;
identifying, by the online planning device, landing sites for the aircraft within the alternate landing area without using pre-calculated trajectories by automatically scanning from above using active sensor technology an unprepared outdoor surface on one or both sides of a road within the alternate landing area; and
responsive to identifying a suitable landing site based on the scanning, automatically landing, by the online planning device, the aircraft at the suitable landing site.

2. The method of claim 1, further comprising:
evaluating, by the online planning device, criteria for the suitable landing site during the scanning including detecting safe operating distances relative the road and one or more of obstacles, vegetation, ground conditions, and inclinations within the unprepared outdoor surface.

3. The method of claim 1, wherein the automatically scanning is performed using the active sensor technology according to a predetermined search pattern.

4. The method of claim 3, wherein the active sensor technology includes at least one of lidar sensors, radar sensors, or camera sensors.

5. The method of claim 1, wherein the unprepared outdoor surface is without pre-marked landing patterns.

6. The method of claim 1, wherein the alternate landing area is defined to be convex in shape and free of obstacles at a defined overflight height.

7. The method of claim 1, further comprising:
automatically transferring control of the aircraft back to the flight control device to steer the aircraft to the exit point if no suitable landing sites are identified based on the scanning.

8. The method of claim 7, further comprising:
determining at least one alternate landing site outside said alternate landing area in advance;
pre-planning an emergency flight trajectory from the exit point to the alternate landing site;
storing said emergency flight trajectory on board the aircraft in a suitable data format for use by the flight control device if no suitable landing sites are identified based on the scanning; and
automatically steering, by the flight control device, the aircraft to the exit point.

9. The method of claim 8, further comprising:
after automatically steering the aircraft to the exit point:
automatically steering, by the flight control device, the aircraft along the emergency flight trajectory to the alternate landing site; and
landing, by the flight control device, the aircraft at the alternate landing site.

10. The method of claim 7, further comprising:
automatically steering the aircraft to the exit point during the scanning if a remaining flight time of the aircraft falls below a safety value.

11. The method of claim 1, wherein the road is usable by medical emergency ground vehicles.

12. A non-transitory computer readable storage medium comprising instructions that, when executed, cause a flight control system and an online planning device of an aircraft configured to operate in a network of fixed vertiports to control the aircraft outside said network of fixed vertiports by:
pre-defining at least one alternate landing area for operating said aircraft outside said network of fixed vertiports, said alternate landing area having at least one entry point and at least one exit point;
pre-planning at least one flight trajectory to the entry point;
automatically steering, with the flight control device, the aircraft along the flight trajectory;
upon reaching the entry point, transferring, with the flight control device, control of the aircraft to an online planning device;
identifying, with the online planning device, landing sites for the aircraft within the alternate landing area without using pre-calculated trajectories by automatically scanning from above using active sensor technology an unprepared outdoor surface on one or both sides of a road within the alternate landing area; and
responsive to identifying a suitable landing site based on the scanning, automatically landing, with the online planning device, the aircraft at the suitable landing site.

13. A system comprising:
an aircraft configured to operate in a network of fixed vertiports, the aircraft including a flight control system and an online planning device operable to control the aircraft outside said network of fixed vertiports by:
pre-defining at least one alternate landing area for operating said aircraft outside said network of fixed vertiports, said alternate landing area having at least one entry point and at least one exit point;
pre-planning at least one flight trajectory to the entry point;
automatically steering, by the flight control device, the aircraft along the flight trajectory;
upon reaching the entry point, transferring, by the flight control device, control of the aircraft to an online planning device;
identifying, by the online planning device, landing sites for the aircraft within the alternate landing area without using pre-calculated trajectories by automatically scanning from above using active sensor technology an unprepared outdoor surface on one or both sides of a road within the alternate landing area; and
responsive to identifying a suitable landing site based on the scanning, automatically landing, by the online planning device, the aircraft at the suitable landing site.

14. The system of claim 13, wherein the online planning device is further operable to:
evaluate criteria for the suitable landing site during the scanning including detecting safe operating distances relative the road and one or more of obstacles, vegetation, ground conditions, and inclinations within the unprepared outdoor surface.

15. The system of claim 13, wherein the using the active sensor technology is according to a predetermined search pattern.

16. The system of claim 15, wherein the active sensor technology includes at least one of lidar sensors, radar sensors, or camera sensors.

17. The system of claim 13, wherein the unprepared outdoor surface is without pre-marked landing patterns.

18. The system of claim 13, wherein the alternate landing area is defined to be convex in shape and free of obstacles at a defined overflight height.

19. The system of claim 13, wherein the flight control device is further operable to:
automatically transfer control of the aircraft back to the flight control device to steer the aircraft to the exit point if no suitable landing sites are identified based on the scanning.

20. The system of claim 13, wherein the road is usable by medical emergency ground vehicles.
